(19) United States
(12) Patent Application Publication
(10) Pub. No.: US 2014/0163144 A1
(43) Pub. Date: Jun. 12, 2014

(54) Biobased Polymer Compositions

(71) Applicants: Jeffrey Jacob Cernohous, Hudson, WI (US); Adam R Pawloski, Lake Elmo, MN (US)

(72) Inventors: Jeffrey Jacob Cernohous, Hudson, WI (US); Adam R Pawloski, Lake Elmo, MN (US)

(73) Assignee: Interfacial Solutions IP, LLC, River Falls, WI (US)

(21) Appl. No.: 13/821,860

(22) PCT Filed: Mar. 23, 2012
(86) PCT No.: PCT/US2012/030237

§ 371 Date: Jan. 16, 2014

Related U.S. Application Data
(60) Provisional application No. 61/466,516, filed on Mar. 23, 2011.

(51) Int. Cl. C08G 64/42; C08K 5/49

(52) U.S. Cl. CPC C08G 64/42; C08K 5/49
USPC 524/100; 525/450; 524/599

(57) ABSTRACT

Polymeric composites are produced by melt processing biobased polymers with an acrylated silicone polyether at temperatures that promote free radical reactions between the bio-based polymer and the acrylated silicone polyether. The bio-based compositions have an excellent balance of mechanical properties and are suitable for flame retardant applications.

### CROSS REFERENCE TO RELATED APPLICATONS

This application claims priority to U.S. Provisional Patent Application No. 61/466,516 filed Mar. 23, 2011, the disclosure of which are herein incorporated by reference in its entirety.

### TECHNICAL FIELD

The present invention relates to a bio-based polymer and an acrylated silicone polyether that in combination form melt processable polymers that possess superior and unexpected mechanical properties.

### BACKGROUND

Polylactic acid polymers (PLA) and other bio-based polymers possess certain physical limitations when compared to petroleum based polymeric materials. The limitations may include their susceptibility to degradation and loss of properties during processing and reprocessing. The admixture of conventional materials with a bio-based polymer composition may adversely impact the physical characteristics of the composition, ultimately rendering the composition unsuitable or undesirable for its intended purpose. Additionally, highly filled bio-based polymers often have inferior physical characteristics compared to competitive materials due to their molecular architecture. Such materials are often incapable of achieving the desired strength and impact characteristics. Other bio-based compositions offer molecular architecture that potentially limits the subsequent processing once the multi-component composition is created.

### SUMMARY

The bio-based polymeric compositions disclosed herein have an excellent balance of mechanical properties and enable the melt processing of the compositions once they are initially admixed. The combination of these attributes is a function of the molecular architecture of the compositions. In one embodiment, the bio-based polymers of this invention are produced by melt processing bio-based polymers with an acrylated silicone polyether at temperatures that promote covalent reactions between the bio-based polymer and acrylated silicone polyether. In one embodiment, the polymer is a bio-based linear polyester.

The composition has a molecular structure that is in part created by the acrylated silicone polyether utilized in the composition. In one embodiment, the acrylated silicone polyether undergoes a free radical homolysis reaction and reacts with the bio-based polyester during melt processing to form a polymeric composite. The degree of interaction of the polymer chains possesses characteristics of a higher molecular weight material while still being subsequently melt processable.

The finished polymer may demonstrate improved mechanical characteristics as indicated by relatively high impact strength (unnotched) when compared to conventional compounded bio-based polymers.

For purposes of the present invention, the following terms used in this application are defined as follows:
“Bio-based Polymer” means a polymeric material or resin that is derived from renewable resources.
“Polymeric Composite” means a mixture of a polymeric material and an additive or filler.
“Melt Processable Composition” means a formulation that is melt processed, typically at elevated temperatures, by means of a conventional polymer processing technique such as extrusion or injection molding, as an example.
“Melt Processing Techniques” means extrusion, injection molding, blow molding, rotomolding, or batch mixing.
“Acrylated Silicone Polyether” means a siloxane polyether copolymer having a one or more pendant acrylate moieties extending from either the siloxane or polyether.

The above summary is not intended to describe each disclosed embodiment or every implementation of the composition. The detailed description that follows more particularly exemplifies illustrative embodiments.

### DETAILED DESCRIPTION

Novel polymers composites are produced by melt processing bio-based polymers with acrylated silicone polyethers. Non-limiting examples of bio-based polymers suitable for practicing the present invention include polysaccharides, peptides, aliphatic polyesters, polyamino acids, polyvinyl alcohol, polyamides, polyalkylene glycols, and copolymers thereof. The bio-based polymers may also include those polymers generally recognized by those of ordinary skill in the art to decompose or degrade into compounds having lower molecular weights. The resulting composite exhibits improved mechanical properties without exhibiting any adverse effects on flexural properties.

In one aspect, the bio-based polymer is a linear polyester. Non-limiting examples of linear polyesters include polylactic acids, poly-L-lactic acid (PLLA), and a random copolymer of L-lactic acid and D-lactic acid, and derivatives thereof. Other non-limiting examples of polyesters include polycaprolactone, polyhydroxybutyric acid, polyhydroxyvaleric acid, polyethylene succinate, polybutylene succinate, polybutylene adipate, polymalic acid, polyglycolic acid, polysuccinate, polyoxalate, polybutylene diglycolate, and polydioxanone.

An acrylated silicone polyether is melt processed with the bio-based polymer to form the polymeric composition. The polyether component may aid in the dispersion and compatibility of the acrylated silicone polyether in the bio-based polymer. Amphiphilic polymers having pendent acrylate moieties are well suited in certain embodiments. In another embodiment, the acrylated silicone polyether agent of this invention include those materials generally sold as TEGO RAD 2250, Acrylated Polyethersiloxane, commercially available from Evonik Inc. (Parsippany, N.J.). The acrylated silicone polyethers are generally included in the polymeric matrix in amounts up to about 20%. In some embodiments, the acrylated silicone polyether may range from 1% to 5%.

Free radical initiators may be employed to assist in the melt processing and inherent reaction between the bio-based polymer and an acrylated silicone polyether. A free radical initiator is a species, that when melt processed, forms reactive free radical moieties. Free radical initiators useful in this invention include organic peroxides and diazocompounds. Non-limiting examples of specific free radical initiators include: benzoyl peroxide, dicumyl peroxide, di-tert-butyl peroxide and azoisobutrylnitrile. The free radical initiator may be included in the melt processable composition at amounts less than 0.25% by weight.

In another embodiment, impact modifying additives may also be added or incorporated into the composition to address desired physical characteristics of the melt processable composition. Non-limiting examples of impact modifiers useful in this invention include: elastomeric copolyesters, polyaklylene glycols and functionalized naturally occurring oils. Examples of elastomeric polyesters include, but are not limited to, those sold under the Neostar (Eastman Chemical Co., Kingsport, Tenn.), Biomax (DuPont, Wilmington, Del.) and Hytrel (DuPont) tradenames. Non-limiting examples of polyalkylene glycols include polyethylene glycols sold under the Carbowax tradename (Dow Chemical Co., Midland, Mich.). Non-limiting examples of functionalized naturally occurring oils include: malinated or epoxidized soybean, linseed or sunflower oils, which are commercially available from Cargill Inc.

The polymer compositions of this invention have an excellent balance of mechanical properties and are melt processable. Certain compositions demonstrate superior impact strengths while maintaining relatively high flexural values. The combination of these attributes is a function of the molecular architecture of the compositions disclosed here. In one embodiment, the bio-based polyesters of this invention are produced by melt processing a linear bio-based polyester with an acrylated silicone polyether at temperatures that promote free radical reactions between the linear biodegradable polyester and the acrylated silicone polyether.

The amount of components in the melt processable may vary depending upon the intended end use application. The polymer may comprise from about 20 to about 99 percent by weight of the final composition. The acrylated silicone polyether agent may be included at a level of up to 20 percent by weight.

In another aspect, flame retardant bio-based polymer compositions are produced by melt processing a polymer, such as a linear bio-based polyester, with an acrylated silicone polyether and one or more flame retardant additives. Any conventional halogenated or non-halogenated flame retardant additives can be utilized in this invention. The bio-based polyester of this invention has improved flame retardancy when compared to a linear bio-based polyester. In one embodiment, the flame retardant polyester, that includes a flame retardant additive demonstrates self extinguishing flame retardant properties. Although halogenated flame retardants can be utilized in this invention, the environmental hazards, biopersistance and toxicity associated with many of these additives make them less viable candidates in bio-based polymer compositions. Non-halogenated flame retardants are more preferred as they do not suffer from these issues. Non-halogenated flame retardant additive materials useful in this invention include inorganic compounds (such as, for example, metal hydroxides, metal sulfates, metal nitrates, carbonate compounds, tin compounds, titanium compounds, zirconium compounds and molybdenum compounds) silica compounds, phosphorous compounds, boric acid containing compounds, organic compounds, and nitrogen compounds. The flame retardant additive may be included in the melt processable composition at levels of up to 80 percent by weight.

Non-limiting examples of desirable non-halogenated phosphorus based flame retardant additives include: ammonium phosphate, ammonium polyphosphate, melamine phosphate, red phosphorus, phosphoric esters, tris(chloroethyl)phosphate, tris(monochloropropyl)phosphate, tris(dichloropropyl) phosphate, triallyl phosphate, tris(3-hydroxypropyl) phosphate, tris(tribromophenyl)phosphate, tris-.beta.-chloropropyl phosphate, tris(dibromophenyl) phosphate, tris(tribromoneopentyl)phosphat-e, tetrakis(2-chloroethyl)ethylenediphosphate, dimethyl methylphosphate, tris(2-chloroethyl) orthophosphate, aromatic condensed phosphates, halogen-containing condensed organophosphates, ethylenebis[tris(2-cyanoet-hyl)]phosphonium bromide, ammonium polyphosphate, .beta.-chloroethyl acid phosphate, butyl pyrophosphate, butyl acid phosphate, butoxyethyl acid phosphate, 2-ethylhexyl acid phosphate, melamine phosphate, halogen-containing phosphates, and phenylphosphonic acid. In one aspect, ammonium polyphosphate is utilized as the flame retardant additive.

In another aspect of the invention, the melt processable composition may contain other additives. Non-limiting examples of conventional additives include: antioxidants, light stabilizers, fibers, blowing agents, foaming additives, antiblocking agents, heat stabilizers, impact modifiers, biocides, compatibilizers, tackifiers, colorants, coupling agents, and pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

The melt processable composition can be prepared by any of a variety of ways. For example, the bio-based polymer, acrylated silicone polyether, optional flame retardant and optional additives can be combined together by any of the blending means usually employed in the plastics industry, such as with a compounding mill, a Banbury mixer, or a mixing extruder. The materials may be used in the form, for example, of a powder, a pellet, or a granular product. The mixing operation is most conveniently carried out at a temperature above the melting point or softening point of the polymer. The resulting melt-blended mixture can be either extruded directly into the form of the final product shape, pelletized, or otherwise comminuted into a desired particulate size or size distribution and fed to an extruder, which typically will be a twin-screw extruder, that melt-processes the blended mixture to form the final product shape. Alternatively, the composition may be molded into a desired form. The resulting composite exhibits superior performance results when the hyper-branched polymer is produced using this protocol.

In another embodiment, the flame retardant additive is melt processed with the bio-based polymer to form a masterbatch. This masterbatch may optionally contain the acrylated silicone polyether. The masterbatch is then let down to the desired level of flame retardant additive in a subsequent melt processing step. This two step process can have the effect of improving the dispersion of the flame retardant additive and the chemical and mechanical properties of the final compound. In an alternative embodiment, the flame retardant masterbatch is made in the presence of the acrylated silicone polyether and a free radical initiator is added during a subsequent processing step. This two step process produces a particularly useful, bio-based flame retardant polymer composition. Those skilled in the art of melt processing polymer compositions are capable of selecting processing steps to achieve a desired level of intermixed components.

Melt-processing typically is performed at a temperature from 80° to 300° C., although optimum operating temperatures are selected depending upon the melting point, melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 11-33, 2001.

The composites of this invention are suitable for manufacturing articles in the construction, electronics, consumer goods and automotive industries. For example, articles incorporating the composition of the present invention may include: molded architectural products, forms, automotive parts, building components, household articles, or electronic hard goods.

The resulting articles produced by melt processing the inventive composition exhibit superior mechanical characteristics. For example, a polymer produced according to the disclosed embodiments may have one or more of an impact strength greater than 265 joules per meter (unnotched) and flexural modulus of greater than 2500 megapascals. In certain embodiments, the ratio of flexural modulus to impact strength may be less than 11:1 and even 5:1 or less. Additionally with the inclusions of a flame retardant additive, the composition exhibits self extinguishing properties under UL 94 test procedures. In certain embodiments, the polymer may have a rating of HB on the UL 94 horizontal flame retardant test. Additionally, with the inclusion of a flame retardant compound, the polymer has one or more of an impact strength greater than 200 joules/meter (unnotched) and flexural modulus of greater than 3000 megapascals. The polymeric composite with a flame retardant composition is capable of achieving a Class1/A rating under the ASTM E84-08 test or the comparable ANSI/UL 723 test. The polymer with a flame retardant composition is also capable of achieving a rating of V2, V1 or V0 on the UL 94 vertical flame retardant test.

### EXAMPLES

Materials used to generate the following examples include:

| Material | Description |
|---|---|
| PLA | Ingeo 2003D poly(lactic acid), commercially |
| | available from NatureWorks LLC (Minneapolis, |
| | MN) |
| Branching Agent 1 | SR494, Ethoxylated Pentaerythritoltetraacrylate, |
| | commercially available from Sartomer USA LLC |
| | (Exton, PA) |
| Branching Agent 2 | TEGO RAD 2250, Acrylated Polyethersiloxane, |
| | commercially available from Evonik Inc. |
| | (Parsippany, NJ) |
| Initiator 1 | Dicumyl Peroxide, commercially available from |
| | Sigma Aldrich (Milwaukee, WI) |

Bio-based polymer compositions were prepared using the following protocol. PLA, Branching Agent and optionally Initiator were dry mixed in a plastic bag and gravity fed into a 26 mm co-rotating twin screw extruder (40:1, L:D) fitted with a four strand die (commercially available from Labtech Engineering, Samutprakarn, Thailand). All samples were processed at 300 rpm screw speed using the following temperature profile: Zone 1-2=180° C., Zone 3-4=180° C., Zone 5-6=180° C., Zone 7-8=180° C., Die=180° C. The resulting strands were subsequently cooled in a water bath and pelletized into 0.64 cm pellets. The resulting pellets were injection molded into test specimens following ASTM D638 (tensile) and D790 (flexural) specifications. Injection molding on bio-based polymer formulations was performed using an 85 ton machine (commercially available from Engel Corporation, York, Pa.) having a barrel and nozzle temperature of 175° C. The flexural and impact properties were subsequently tested as specified in ASTM D790 and D256 respectively.

Table 1 gives the formulations for bio-based polymer compositions comparative example CE1 and examples 1-4 that were produced. Table 2 gives the mechanical and flame retardant properties for bio-based polymer compositions comparative example CE1 and examples 1-4.

TABLE 1
Formulations for Bio-based Polymer Formulations
Comparative Examples CE1-CE3 and Examples 1-4

| | | | Branching | | |
|---|---|---|---|---|---|
| | PLA | FR | Agent 1 | Branching Agent 2 | Initiator |
| Example | (wt %) | (wt %) | (wt %) | (wt %) | (wt %) |
| CE1 | 100 | — | — | — | — |
| CE2 | 95 | — | 5 | — | — |
| 1 | 99 | — | — | 1 | — |
| 2 | 97.5 | — | — | 2.5 | — |
| 3 | 95 | — | — | 5 | — |
| CE3 | 94.75 | — | 5 | — | 0.25 |
| 4 | 94.75 | — | — | 5 | 0.25 |

TABLE 2
Mechanical Properties of Comparative
Examples CE1-CE3 and Examples 1-4

| | | | Unnotched |
|---|---|---|---|
| | Flexural | Flexural | Impact |
| | Modulus | Strength | Strength |
| Example | (MPa) | (MPa) | (J/m) |
| CE1 | 3060 | 110 | 227 |
| CE2 | 2800 | 100 | 158 |
| 1 | 3000 | 103 | 273 |
| 2 | 2940 | 93 | 500 |
| 3 | 2850 | 82 | 605 |
| CE3 | 2850 | 85 | 161 |
| 4 | 2870 | 104 | 516 |

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

1. A composition comprising a melt processable polymer derived from a bio-based polymer and an acrylated silicone polyether.

2. A composition according to claim 1, wherein the acrylated silicone polyether is a compound that contains at least two ethylenically unsaturated sites.

3. A composition according to claim 1, wherein the melt processable polymer is also derived from a free radical initiator.

4. A composition according, to claim 1, wherein the melt processable polymer has a ratio of flexural modulus to impact strength of less than 11:1.

5. A composition according to claim 1, wherein the melt processable polymer has a rating of HB on the UL 94 horizontal flame retardant test.

6. A composition according to claim 1, further comprising a flame retardant additive.

7. A composition according to claim 6, wherein the flame retardant additive composition is a phosphorus based compound.

8. A composition according to claim 7, wherein the flame retardant additive composition is melamine phosphate.

9. A composition according to claim 6, wherein the melt processable polymer has a rating of V2, V1 or V0 on the UL 94 vertical flame retardant test.

10. A composition according to claim 7, wherein the melt processable polymer exhibits self extinguishing properties under UL 94 test procedures.

11. A composition according to claim 1, wherein the bio-based polymer is a polyester.

12. A composition according to claim 11, wherein the polyester includes polycaprolactone, polyhydroxybutyric acid, polyhydroxyvaleric acid, polyethylene succinate, polybutylene succinate, polybutylene adipate, polymalic acid, polyglycolic acid, polysuccinate, polyoxalate, polybutylene diglycolate, polydioxanone, and polylactic acid.

13. A composition according to claim 1, wherein the biobased polymer includes polysaccharides, peptides, aliphatic polyesters, polyamino acids, polyvinyl alcohol, polyamides, polyalkylene glycols, and copolymers thereof.

14. A composition according to claim 1, wherein the composition has one or more of an impact strength greater than 265 joules/meter (unnotched) and flexural modulus of greater than 2500 megapascals.

15. A composition according to claim 6, wherein the composition has one or more of an impact strength greater than 200 joules/meter (unnotched) and flexural modulus of greater than 3000 megapascals.

16. A method comprising melt processing a bio-based polymer and an acrylated silicone polyether to form a melt processable polymer.

17. A method comprising forming an article by melt processing the melt processable polymer of claim 1.
